(19) United States
(12) Patent Application Publication
(10) Pub. No.: US 2010/0225622 A1
(43) Pub. Date: Sep. 9, 2010

(54) DRIVING APPARATUS

(75) Inventors: Chia-Wei Wang, Taipei City (TW); Chin-Fa Kao, Taipei City (TW); Shih-Chung Huang, Taipei City (TW)

Correspondence Address: J C PATENTS, 4 VENTURE, SUITE 250, IRVINE, CA, 92618, US

(73) Assignee: BEYOND INNOVATION TECHNOLOGY CO., LTD., Taipei City (TW)

(21) Appl. No.: 12/779,550

(22) Filed: May 13, 2010

Related U.S. Application Data
(63) Continuation of application No. 11/669,426, filed on Jan. 31, 2007.

(30) Foreign Application Priority Data
Nov. 9, 2006 (TW) 95141460

(51) Int. Cl. G06F 3/038

(52) U.S. Cl. 345/204

(57) ABSTRACT

A driving apparatus for driving a plurality of loads is provided. The driving apparatus includes a control unit, a driving unit, a current adjusting unit, and a detecting unit. The control unit outputs a control signal. The driving unit generates a driving signal according to the control unit to drive loads. The current adjusting unit is coupled to the loads to adjust the current passing through the same. The detecting unit is coupled to the current adjusting unit to detect a state of the current adjusting unit to generate a detecting signal. Here, the control unit adjusts the control signal according to the detecting signal.

### CROSS-REFERENCE TO RELATED APPLICATION

This application is a continuation of and claims the priority benefit of patent application Ser. No. 11/669,426, filed on Jan. 31, 2007, now pending, which claims the priority benefit of Taiwan patent application serial no. 95141460, filed on Nov. 9, 2006. The entirety of each of the above-mentioned patent applications is hereby incorporated by reference herein and made a part of this specification.

### BACKGROUND OF THE INVENTION

1. Field of the Invention

The present invention relates to a driving apparatus, and more particularly, to a driving apparatus of a light emitting diode (LED).

2. Description of Related Art

Nowadays, the backlight module for providing a light source is required for a great number of electronic products e.g. LCDs. Generally speaking, the backlight module mainly includes a driving apparatus and a plurality of light emitting elements e.g. LED devices. The driving apparatus drives the light emitting elements so as to provide light sources.

FIG. 1 is a schematic view of a conventional driving apparatus for driving a plurality of loads. The loads refer to LED devices 10. The driving apparatus 1 includes a control unit 11, a driving unit 13, and a feedback unit 15. The control unit 11 outputs a control signal S_{c} to the driving unit 13, such that the driving unit 13 generates a driving signal S_{d} according to the control signal S_{c} and drives a plurality of the LED devices 10. On the other hand, the driving apparatus 1 generates a feedback signal S_{f} according to the driving signal S_{d} through the feedback unit 15. The control unit 11 adjusts the outputted control signal S_{c} according to the feedback signal S_{f}, such that the driving unit 13 outputs the stable driving signal S_{d}, and that the LED devices 10 function under stable voltage.

Nevertheless, each of the LEDs in the LED devices 10 has various characteristics. For example, each of the LEDs contains different turn-on voltages, which leads to differences in the current passing through each of the LED devices 10. Accordingly, the brightness of each of the LED devices 10 is not uniform.

To sum up, it is a critical issue at this current stage about how to provide a driving apparatus of a LED capable of reducing differences in the current passing through the LED.

### SUMMARY OF THE INVENTION

To resolve the aforesaid issue, the present invention provides a driving apparatus of a LED and a method thereof, so as to reduce differences in the current passing through the LED.

The present invention further provides a driving apparatus of a LED and a method thereof, so as to reduce a power consumption of the driving apparatus.

To achieve these and other advantages and in accordance with the purpose of the invention, the present invention provides a driving apparatus for driving a plurality of loads. The driving apparatus includes a driving unit, a current adjusting unit, a detecting unit and a control unit. The driving unit generates a driving signal. The current adjusting unit, coupled to the driving unit, comprises a first transistor, a first resistor, and a plurality of second transistors. A first terminal of the first transistor receives the driving signal; a second terminal of the first transistor is coupled to a gate terminal of the first transistor. The first resistor is coupled between a first voltage and the second terminal of the first transistor. A first terminal of each of the second transistors is coupled to the first terminal of the first transistor, a gate terminal of each of the second transistors is coupled to the gate terminal of the first transistor, and a second terminal of each of the second transistors is coupled to each of the loads. The detecting unit, coupled to the current adjusting unit, detects a plurality of voltage differences between the first terminal and the second terminal of each of the second transistors to output a detection signal. The control unit, coupled to the detecting unit and the driving unit, controls the driving unit according to the detection signal.

In other embodiment, the present invention provides a driving apparatus for driving a plurality of loads a control unit, a driving unit, a current adjusting unit, and a detecting unit. The control unit outputs a control signal. The driving unit generates a driving signal according to the control signal to drive the loads. The current adjusting unit is coupled to the loads and adjusts the current through the same. The detecting unit is coupled to the current adjusting unit and detects a state of the current adjusting unit to generate a detecting signal. Here, the control unit adjusts the control signal according to the detecting signal.

In addition, the present invention further provides a driving method including the following steps: first, a control signal is provided. A driving signal is then generated according to the control signal to drive the loads. Next, a current adjusting unit is provided to adjust the current passing through the loads. Thereafter, the state of the current adjusting unit is detected to generate a detecting signal. Eternally, the control signal is adjusted according to the detecting signal.

As stated above, the current adjusting unit adjusts the current passing through the loads with use of the driving apparatus and the method thereof disclosed by the present invention. Moreover, the detecting unit detects the state of the current adjusting unit to adjust the control signal and the driving signal. Thereby, the voltage across the current adjusting unit falls, thus resulting in reduction of the power consumption of the current adjusting unit.

### BRIEF DESCRIPTION OF THE DRAWINGS

FIG. 1 is a schematic view of a conventional driving apparatus for driving a plurality of loads.

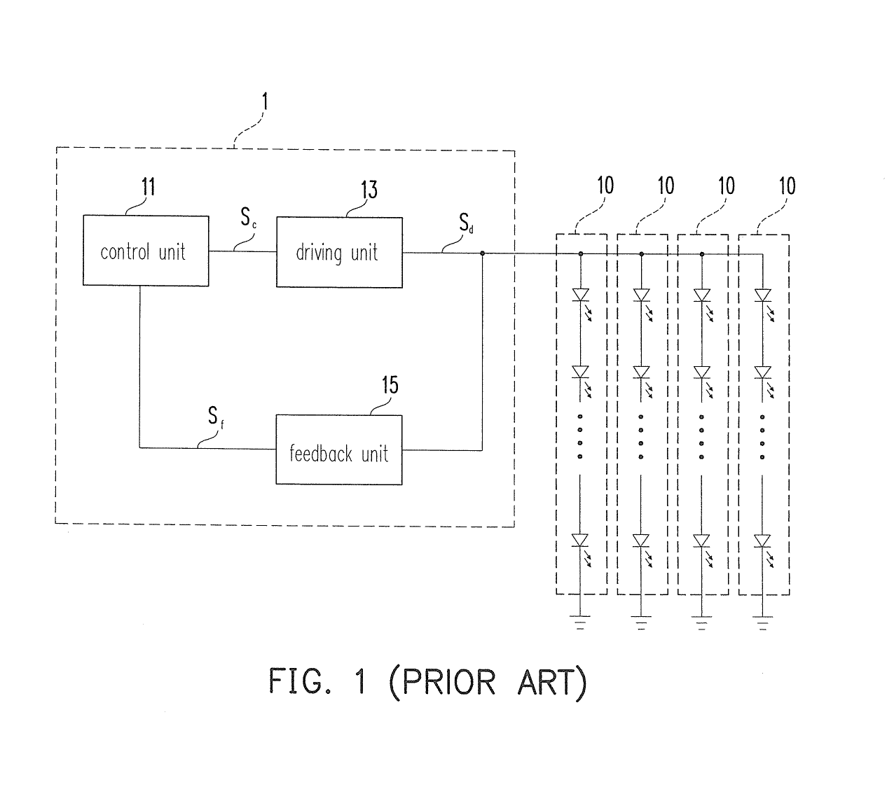

FIG. 2 is a schematic view of a driving apparatus for driving a plurality of loads according to a preferred embodiment of the present invention.

FIG. 3 is a schematic circuit diagram depicting the driving apparatus for driving the plurality of loads according to a preferred embodiment of the present invention.

FIG. 4 is a schematic view of a current adjusting unit in another mode.

FIG. 5 is a schematic circuit diagram depicting the driving apparatus for driving a plurality of loads according to another preferred embodiment of the present invention.

FIG. 6 is a schematic circuit diagram depicting the driving apparatus for driving a plurality of loads according to yet another preferred embodiment of the present invention.

### DESCRIPTION OF EMBODIMENTS

The driving apparatus according to the embodiments of the invention are illustrated with reference to the relative drawings as follows, wherein the same elements are illustrated with the same reference symbols.

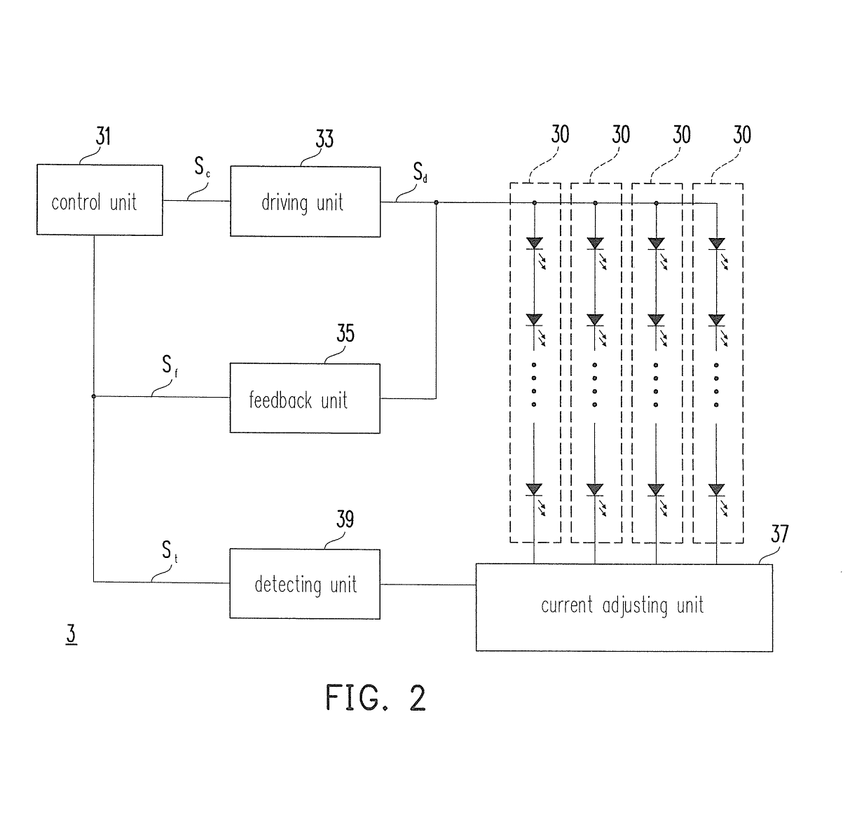

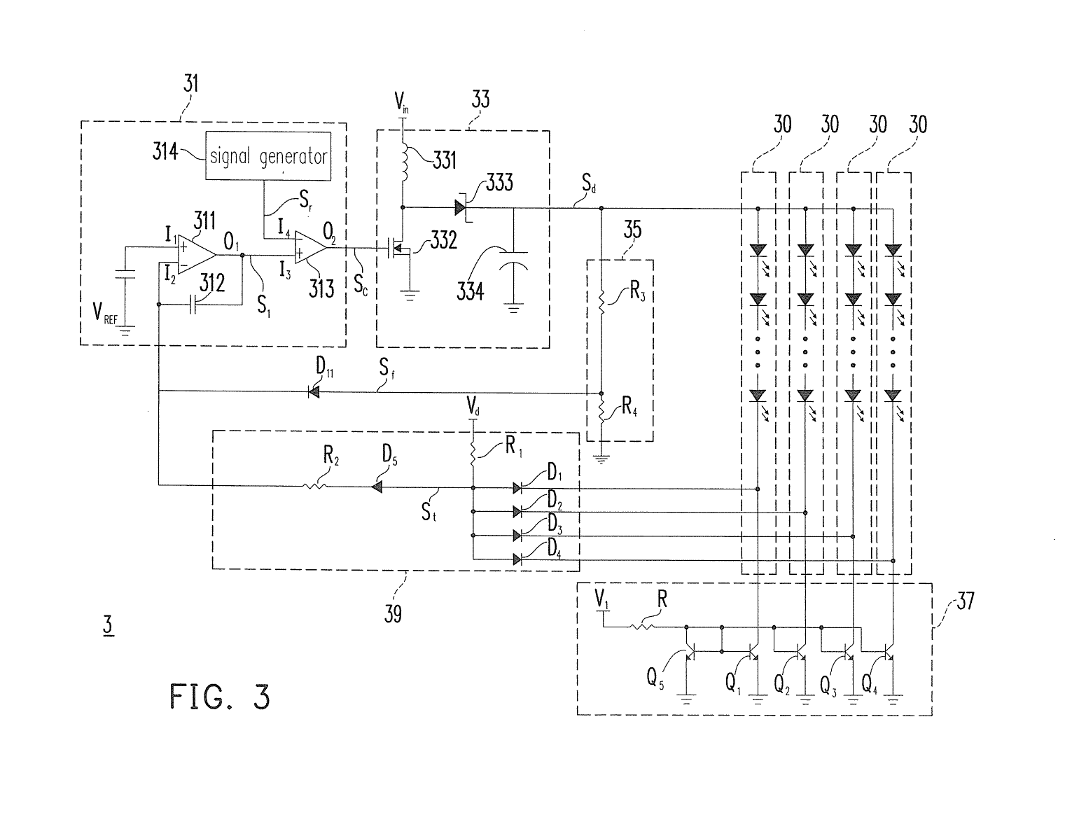

Please refer to FIGS. 2 and 3. The loads 30 can be LED devices including a plurality of LEDs connected in series.

As shown in FIG. 2, the driving apparatus 3 of the present embodiment includes a control unit 31, a driving unit 33, a current adjusting unit 37, and a detecting unit 39. The control unit 31 can be a pulse width modulation (PWM) regulator used for outputting a control signal S_{c}. In the present embodiment, the control signal S_{c} is a PWM signal, and the driving unit 33 is a DC/DC converter which generates a driving signal S_{d} according to the control signal S_{c} to drive the plurality of the loads 30.

Moreover, the current adjusting unit 37 is coupled to the loads 30 for adjusting the current passing through the same. In the present embodiment, the current adjusting unit 37 adjusts said current to be approximately equal, such that the loads 30 have equivalent brightness. In addition, the detecting unit 39 of the present embodiment is coupled to the current adjusting unit 37 to detect a state of the same and to further generate a detecting signal Sₜ. Then, the control unit 31 adjusts a duty cycle of the control signal S_{c} according to the detecting signal Sₜ, and the driving unit 33 adjusts the driving signal S_{d} according to adjusted control signal S_{c}.

Furthermore, the driving apparatus 3 of the present embodiment further includes a feedback unit 35. The feedback unit 35 generates a feedback signal S_{f} according to the driving signal S_{d}, and the control unit 31 adjusts the duty cycle of the control signal S_{c} according to the feedback signal S_{f}. Given that all of the loads 30 fail, and no signal is detected by the detecting unit 39, the controlling of the driving unit 33 implemented by the control unit 31 is mainly determined by the feedback signal S_{f} generated by the feedback unit 35. The feedback unit 35, however, can be omitted in other embodiments.

Referring to FIG. 3, the control unit 31 of the present embodiment includes a first comparator 311, a compensator 312, a second comparator 313, and a signal generator 314. The signal generator 314 generates a reference signal Sᵣ. In the present embodiment, the reference signal Sᵣ can be a triangular wave signal or a saw-tooth wave signal, and the compensator 312 includes at least a capacitor. The first comparator 311 has a first input terminal I₁, a second input terminal I₂, and a first output terminal O₁. The first input terminal I₁ receives a reference voltage V_{REF}, the second input terminal I₂ is coupled to the first output terminal O₁ through the compensator 312 and receives the detecting signal Sₜ. On the other hand, the second comparator 313 has a third input terminal I₃, a fourth input terminal I₄, and a second output terminal O₂. The third input terminal I₃ is coupled to the first output terminal O₁, the fourth input terminal receives the reference signal Sᵣ, and the second output terminal O₂ outputs the control signal S_{c}. In the present embodiment, the first and the third input terminals I₁ and I₃ are non-inverting input terminals, while the second and the fourth input terminals I₂ and I₄ are inverting input terminals. In addition, the driving unit 33 mainly includes a inductor 331, a switch 332, a Schottky diode 333, and a capacitor 334. A first terminal of the inductor 331 is coupled to an input voltage Vᵢₙ, and the switch 332 determines if a second terminal of the inductor 331 is grounded through the switch 332 according to the control signal S_{c}. An anode terminal of the Schottky diode 333 is coupled to the second terminal of the inductor 331 and a cathode terminal thereof is grounded through the capacitor 334 so as to output electrical energy to the capacitor 334 and the loads 30. Thereby, the capacitor 334 across the inductor 331 and the ground generates the driving signal S_{d}. In the present embodiment, the driving unit 33 determines the value of the driving signal S_{d} according to the duty cycle of the control signal S_{c}.

Moreover, the current adjusting unit 37 provided by the present embodiment can be a current mirror circuit which includes a plurality of transistors Q₁˜Q₅. Here, the bases of the transistors Q₁˜Q₅ are coupled to one another, the emitters of the transistors Q₁˜Q₅ are collectively grounded, and each of the collectors (receiving terminals) of the transistors Q₁˜Q₄ is coupled to one of the loads 30, respectively. Furthermore, the collector of the transistor Q₅ is coupled to the base thereof and to a voltage V1 through a resister R, such that a reference current of the current mirror circuit can be configured. Thereby, the current passing through the loads 30 is approximately equal due to the characteristics of the current mirror circuit.

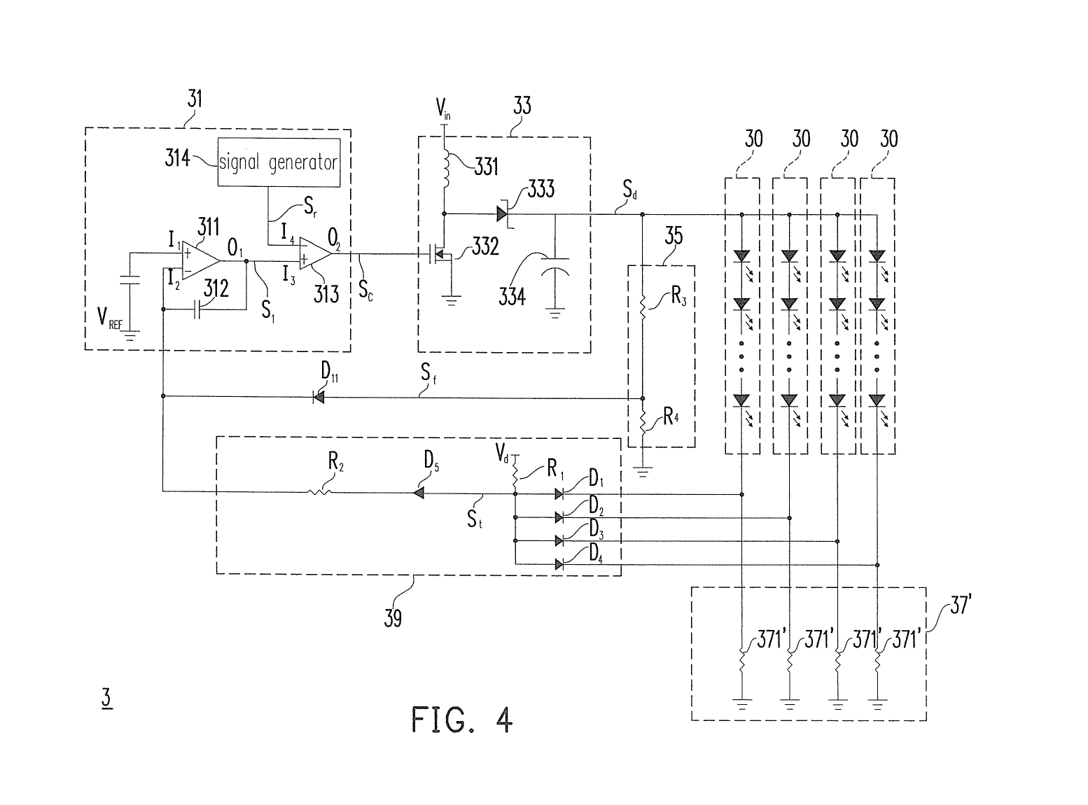

FIG. 4 is a schematic view of the current adjusting unit in another mode. In the present embodiment, the current adjusting unit 37′ includes a plurality of resistors 371′. A first terminal of each of the resistors 371′ is coupled to one of the loads 30, respectively. Through the resistors 371′, the current passing through the loads 30 is adjusted so as to approximately equalize said current. Although the current adjusting unit 37 is merely described in FIGS. 3 and 4, the present invention is certainly not limited thereto. According to other embodiments, the current adjusting unit 37 can be either a low voltage drop linear chip or manufactured by other current-adjusting technologies understood by those skilled in the art.

Again, referring to FIG. 3, the detecting unit 39 includes a plurality of detecting terminals and a signal generator. Here, the detecting unit 39 can be implemented by a plurality of diodes and resistors. In the present embodiment, the detecting unit 39 includes a plurality of diodes D₁˜D₅ and resistors R₁ and R₂. A first terminal of the resistor R₁ is coupled to a voltage source V_{d}. Anode terminals of the diodes D₁˜D₄ are coupled to a second terminal of the resistor R₁, while cathode terminals (detecting terminals) thereof are coupled to the collectors of the corresponding transistors Q₁˜Q₄. The anode terminal of the diode D₅ is coupled to the second terminal of the resistor R₁, the cathode terminal thereof is coupled to a first terminal of the resistor R₂, and a second terminal of the resistor R₂ is coupled to the second input terminal I₂ of the first comparator 311. It should be noted that the resistor R₂ and the diode D₅ can be omitted in other embodiments; namely, the same effect can be achieved through a direct connection between the second terminal of the resistor R₁ and the second input terminal I₂ of the first comparator 311.

In the present embodiment, the diodes D₁˜D₄ detect the cross voltage (the voltage across the collectors and the emitters) of the transistors Q₁˜Q₄, generate the detecting signal Sₜ according to the minimum cross voltage, and transmit the detecting signal Sₜ to the second input terminal I₂ of the first comparator 311. Thereby, the control unit 31 shortens the duty cycle of the control signal S_{c} according to the detecting signal Sₜ, and the value of the driving signal S_{d} is further reduced, thus the potential difference applied to the current adjusting unit 37 is decreased. Besides, as indicated in FIG. 3, the diodes D₁˜D₄ are employed to detect the cross voltage of each of the transistors Q₁˜Q₄. However, in consideration of unnoticeable characteristics of the loads 30, only one of the diodes D₁˜D₄ is required to detect one of the transistors Q₁˜Q₄ according to other embodiments, which achieves the same effects as demonstrated above.

Furthermore, the feedback unit 35 includes two resistors R₃ and R₄. A first terminal of the resistor R₃ is coupled to the driving unit 33 to detect the driving signal S_{d}, a second terminal of the resistor R₃ is coupled to a first terminal of the resistor R₄, and a second terminal of the resistor R₄ is grounded. Here, the first terminal of the resistor R₄ generates the feedback signal S_{f} and transmits the same to the second input terminal I₂ of the first comparator 311. Thereby, the control unit 31 is capable of adjusting the duty cycle of the outputted control signal S_{c} according to the feedback signal S_{f}. Note that the feedback signal S_{f} can be a current signal or a voltage signal. In the present embodiment, the feedback signal S_{f} is the voltage signal, but the present invention is not limited thereto.

According to the present embodiment, the method for driving the driving apparatus 3 includes the following steps. First, the control unit 31 provides the control signal S_{c}, and the driving unit 33 generates the driving signal S_{d} according to the control signal S_{c} to drive the loads 30. Through the current adjusting unit 37 of the driving apparatus 3, the current passing through the loads 30 are approximately equal. Then, the detecting unit 39 detects potential difference applied to the current adjusting unit 37 to generate the detecting signal Sₜ. Moreover, the first comparator 311 generates a comparison signal S₁ according to the detecting signal Sₜ, the feedback signal S_{f}, and the reference voltage V_{REF}. The second comparator 313 adjusts the duty cycle of the control signal S_{c} according to the comparison signal S₁ and the reference signal Sᵣ to further adjust the value of the driving signal S_{d}.

Accordingly, when the detecting unit 39 detects excessive voltage across the current adjusting unit 37, the detecting signal Sₜ is transmitted to the control unit 31 to adjust the duty cycle of the control signal S_{c}. Thereby, the value of the driving signal S_{d} is reduced, thus leading to a decrease in the voltage across the current adjusting unit 37.

To better illustrate the present invention, other embodiments are provided hereinafter. In the present embodiment, a predetermined value of the driving signal S_{d} is 26 volts, and the driving voltage required by the LED devices is preset as 20 volts. In other words, a potential difference applied to the current adjusting unit 37 is 6 volts, which brings about excessive power consumption generated by the current adjusting unit 37. Nevertheless, according to the potential difference applied to the current adjusting unit 37, the detecting unit 39 of the present embodiment is capable of transmitting the detecting signal Sₜ indicating 6 volts voltage drop to the control unit 31. After the detecting signal Sₜ is received by the control unit 31, the duty cycle of the control signal S_{c} is reduced, and the value of the driving signal S_{d} is decreased to a certain value e.g. to 21 volts. Thereby, the potential difference applied to the current adjusting unit 37 is lowered, thus leading to a decrease in power consumption generated by the current adjusting unit 37.

In the present embodiment, the control unit 31, the current adjusting unit 37, and the detecting unit 39 are usually disposed in the same integrated circuit. It is of certainty for those skilled in the art to understand other devices can also be disposed in the integrated circuit according to other embodiments.

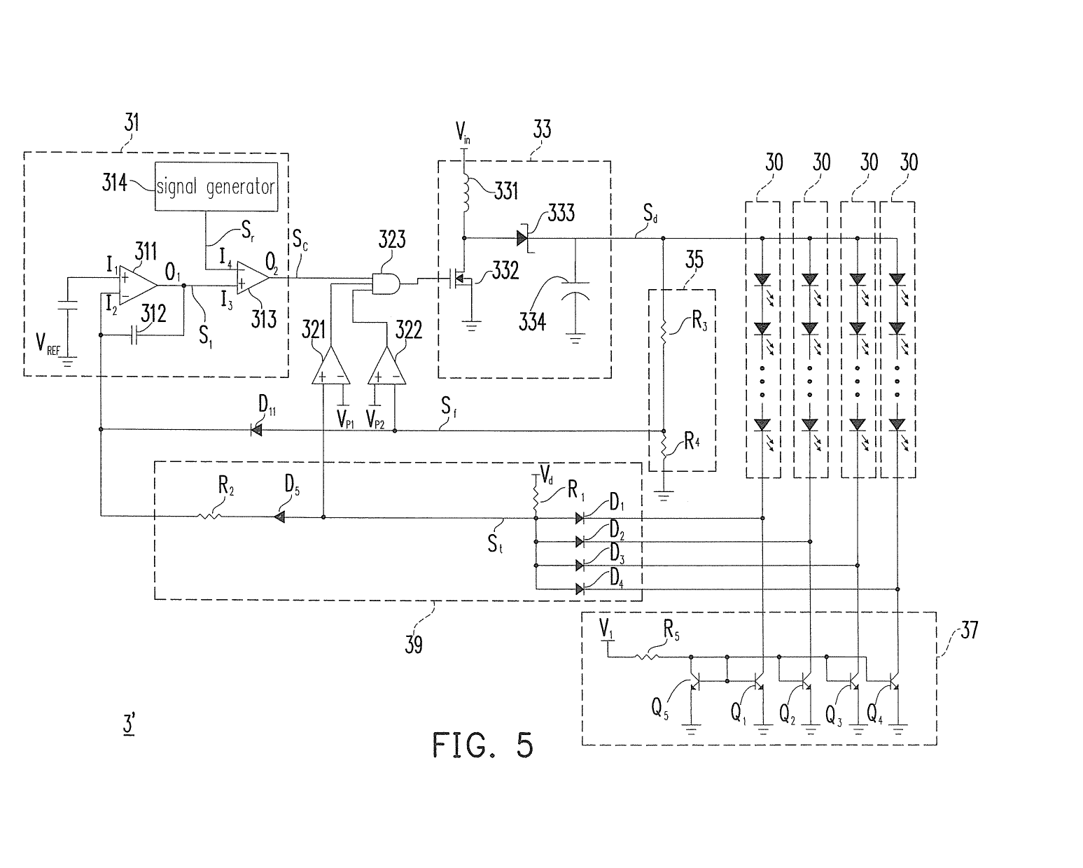

FIG. 5 is a schematic circuit diagram depicting the driving apparatus for driving the plurality of loads according to another preferred embodiment of the present invention.

The difference between the driving apparatus 3′ and the driving apparatus 3 disclosed in FIG. 3 lies in that the driving apparatus 3′ further includes a first protection unit 321, a second protection unit 322, and an AND gate 323. According to the present embodiment, each of the first and the second protection units 321 and 323 is a comparator. Here, a positive input terminal of the first protection unit 321 is coupled to the second terminal of the resistor R₁ to receive the detecting signal Sₜ while a negative input terminal of the first protection unit 321 receives a first reference value V_{P1} and generates a first protection signal according to the detecting signal Sₜ and the first reference value V_{P1}. On the other hand, the positive input terminal of the second protection unit 322 receives a second reference value V_{P2} while the negative input terminal of the second protection unit 322 is coupled to the first terminal of the resistor R₄ to receive the feedback signal S_{f} and to generate a second protection signal according to the feedback signal S_{f} and the second reference value V_{P2}.

Besides, the AND gate 323 coupled to the control unit 31, the first protection unit 321, the second protection unit 322, and the driving unit 33 selectively outputs the control signal S_{c} according to the first and the second protection signals. The driving apparatus of the present embodiment is operated in the following way. As one of the loads 30 fails, the value of the detecting signal Sₜ is less than the first reference value V_{P1}, and the first protection unit 321 then generates the first protection signal. When the first protection signal is received by the AND gate 323, the output of the control signal S_{C} is terminated. Thereby, the driving unit 33 stops outputting the driving signal S_{d}, which achieves better protection.

Likewise, as the driving signal S_{d} reaches an unreasonably high value, the value of the feedback signal S_{f} exceeds the second reference value V_{P2}, and the second protection unit 322 then generates the second protection signal. When the second protection signal is received by the AND gate 323, the output of the control signal S_{C} is terminated. Thereby, the driving unit 33 stops outputting the driving signal S_{d}, which achieves better protection. It should be noted that the first and the second reference voltage values V_{P1} and V_{P2} can be properly determined by actual application conditions, and thus the voltage value is not limited as such.

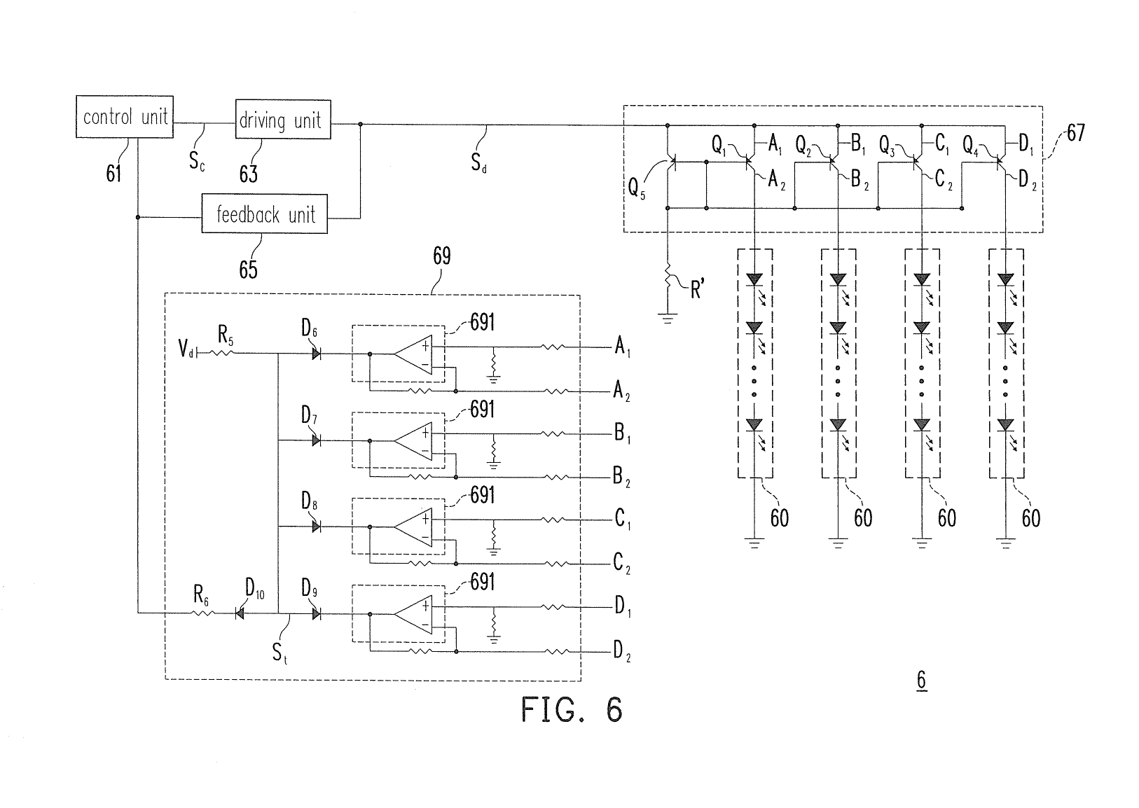

FIG. 6 is a schematic circuit diagram depicting the driving apparatus for driving the plurality of loads according to yet another preferred embodiment of the present invention. The driving apparatus 6 of the present embodiment includes a control unit 61, a driving unit 63, a feedback unit 65, a current adjusting unit 67, and a detecting unit 69. Here, the components incorporated and the effects achieved by the control unit 61, the driving unit 63, and the feedback unit 65 are the same as by the control unit 31, the driving unit 33, and the feedback unit 35. Therefore, no further description is provided hereinafter.

The current adjusting unit 67 is coupled between the driving unit 63 and the loads 60 to equalize the current passing through the loads 60. Moreover, the current adjusting unit 67 provided by the present embodiment is a current mirror circuit which includes a plurality of transistors Q₁˜Q₅. The bases of the transistors Q₁˜Q₅ are coupled to one another, the emitters of the transistors Q₁˜Q₅ are collectively coupled to the driving unit, and each of the collectors of the transistors Q₁˜Q₄ is coupled to one of the loads 60, respectively. The collector and the base of the transistor Q₅ are coupled to each other and grounded through a resistor R′, so as to approximately equalize the current passing through the loads 60.

In addition, the detecting unit 69 of the present embodiment includes a plurality of substractors 691, a plurality of diodes D₆˜D₁₀, and resistors R₅ and R₆. Each of the subtractors 691 has two input terminals and one output terminal. Two of the input terminals are coupled to the current adjusting unit 67 respectively to obtain the potential difference applied to the current adjusting unit 67. In the present embodiment, two of the input terminals are coupled to the collectors and the emitters of the transistors Q₁˜Q₄, respectively.

Moreover, a first terminal of the resistor R₅ is coupled to a voltage source V_{d}. Anode terminals of the diodes D₆˜D₉ are coupled to a second terminal of the resistor R₅, while cathode terminals thereof are coupled to the output terminal of each of the corresponding subtractors 691, respectively. The cathode terminal of the diode D₁₀ is coupled to a first terminal of the resistor R₆, and a second terminal of the resistor R₆ is coupled to the control unit 61 to output the detecting signal Sₜ. The control unit 61 adjusts the duty cycle of the control signal S_{c} according to the detecting signal Sₜ in the same way as illustrated above, and therefore no further description is provided hereinafter.

Besides, as indicated in FIG. 6, a plurality of the subtractors 691 is adopted to detect the cross voltage of each of the transistors Q₁˜Q₄. However, in consideration of unnoticeable characteristics of the loads 60, only one of the subtractors 691 is required to detect one of the transistors Q₁˜Q₄ according to other embodiments, which achieves the same effects as demonstrated above.

On the other hand, the present invention also relates to a chip disclosed in the following preferred embodiment. The chip provided by the present embodiment includes a current adjusting unit and a detecting unit. Said chip can be used cooperatively with a control unit and a driving unit. Here, the components incorporated by, the connecting relationship of, and the effects achieved by the current adjusting unit, the detecting unit, the control unit, and the driving unit in the present embodiment are the same as said current adjusting unit 37, said detecting unit 39, said control unit 31, and said driving unit 33, and thus no further description is provided hereinafter.

In view of the foregoing, the current adjusting unit adjusts the current passing through the loads in accordance with the driving apparatus and the method thereof disclosed in the present invention. Moreover, the detecting unit detects the state of the current adjusting unit to adjust the control signal and the driving signal. Thereby, the voltage across the current adjusting unit falls, thus resulting in reduction of the power consumption of the current adjusting unit.

It will be apparent to those skilled in the art that various modifications and variations can be made to the structure of the present invention without departing from the scope or spirit of the invention. As provided above, it is intended that the specification and examples to be considered as exemplary only, with a true scope and spirit of the invention being indicated by the following claims and their equivalents.

What is claimed is:

1. A driving apparatus for driving a plurality of loads, comprising:
a driving unit for generating a driving signal;
a current adjusting unit coupled to the driving unit, including:
a first transistor, wherein a first terminal of the first transistor receives the driving signal, a second terminal of the first transistor is coupled to a gate terminal of the first transistor;
a first resistor coupled between a first voltage and the second terminal of the first transistor; and
a plurality of second transistors, wherein a first terminal of each of the second transistors is coupled to the first terminal of the first transistor, a gate terminal of each of the second transistors is coupled to the gate terminal of the first transistor, a second terminal of each of the second transistors is coupled to each of the loads;
a detecting unit coupled to the current adjusting unit for detecting a plurality of voltage differences between the first terminal and the second terminal of each of the second transistors to output a detection signal; and
a control unit coupled to the detecting unit and the driving unit for controlling the driving unit according to the detection signal.

2. The driving apparatus of claim 1, the detecting unit comprising:
a plurality of second resistors, wherein a first terminal of each of the second resistors is coupled to the first terminal of each of the second transistors;
a plurality of third resistors, wherein a first terminal of each of the third resistors is coupled to a second terminal of each of the second resistors, a second terminal of each of the third resistors is coupled to a second voltage;
a plurality of fourth resistors, wherein a first terminal of each of the fourth resistors is coupled to the second terminal of each of the second transistors;
a plurality of fifth resistors, wherein a first terminal of each of the fifth resistors is coupled to a second terminal of each of the fourth resistors;
a plurality of subtractors, wherein a first input terminal of each of the subtractors is coupled to a first terminal of each of the third resistors, a second input terminal of each of the subtractors is coupled to a first terminal of each of the fifth resistors, an output terminal of each of the subtractors is coupled to a second terminal of each of the fifth resistors;
a plurality of first diodes, wherein a cathode terminal of each of the first diodes is coupled to the output terminal of the subtractors;
a sixth resistor, wherein a first terminal of the sixth resistor is coupled to a third voltage, the second terminal of the sixth resistor is coupled to an anode of each of the first diodes;
a second diode, wherein an anode terminal of the second diode is coupled to the second terminal of the sixth resistor; and
a seventh resistor, wherein the first terminal of the seventh resistor is coupled to the cathode terminal of the second diode, the second terminal of the seventh resistor is coupled to control unit.

3. The driving apparatus of claim 1, further comprising:
a feedback unit, including:
a first resistor, wherein a first terminal of the first resistor is coupled to the first terminal of the first transistor; and
a second resistor, wherein a first terminal of the second resistor is coupled to the second terminal of the first transistor, a second terminal of the second resistor is coupled to a second voltage; and
a diode, wherein a cathode terminal of the diode is coupled to the first terminal of the second resistor, an anode terminal of the diode is coupled to the control unit.

4. The driving apparatus of claim 1, wherein the control unit comprising:
a first capacitor, wherein a first terminal of the first capacitor is coupled to a second voltage;
a first comparator, wherein a first input terminal of the first comparator is coupled to a second terminal of the first capacitor, a second input terminal of the first comparator is coupled to the detecting unit to receive the detection signal;
a second capacitor, wherein a first terminal of the second capacitor is coupled to an output terminal of the first comparator, a second terminal of the second capacitor is coupled to the second input terminal of the first comparator;
a second comparator, wherein a first input terminal of the second comparator is coupled to the output terminal of the first comparator, an output terminal of the second comparator is coupled to the driving unit; and
a signal generator coupled to a second input terminal of the second comparator.

5. The driving apparatus of claim 1, wherein the detecting unit comprising:
an inductor, wherein a first terminal of the inductor is coupled to a second voltage;
a third transistor, wherein a first terminal of the third transistor is coupled to a second terminal of the inductor, a second terminal of the third transistor is coupled to a third voltage, a gate terminal of the inductor is coupled to the control unit;
a Schottky diode, wherein an anode of the Schottky diode is coupled to the first terminal of the third transistor, an cathode of the Schottky diode is coupled to the first terminal of the first transistor; and
a capacitor coupled between a fourth voltage and the cathode of the Schottky diode.
